(19) United States
(12) Patent Application Publication
(10) Pub. No.: US 2009/0208117 A1
(43) Pub. Date: Aug. 20, 2009

(54) FAST BLOCK MATCHING IN DIGITAL IMAGES

(76) Inventor: Juliet Eichen, Toulouse (FR)

Correspondence Address: SCHIFF HARDIN, LLP;PATENT DEPARTMENT, 6600 SEARS TOWER, CHICAGO, IL, 60606-6473, US

(21) Appl. No.: 12/389,574

(22) Filed: Feb. 20, 2009

(30) Foreign Application Priority Data
Feb. 20, 2008 (GB) 0803066.0

(51) Int. Cl. G06K 9/68

(52) U.S. Cl. 382/218

(57) ABSTRACT

A technique is described which reduces the computational load associated with block matching for pattern recognition between images by intelligent selection and updating of rejection criteria.

### BACKGROUND OF THE INVENTION

1. Field of the Invention

The present invention is concerned with processing of digital images and, in particular, with the problem of block or pattern matching.

2. Description of the Prior Art

Block matching is a fundamental operation applied in many image processing algorithms such as registration or motion estimation. In image registration, the objective is to align two images, a source and a target, of the same object taken at different times or under different conditions in the same geometry. Block matching may be used to perform registration by aligning small patches in the pair of images and estimating an overall parametric or non-parametric motion field.

FIG. 1 shows how block matching finds the best match by considering possible locations for the pattern in the template.

Block matching proceeds by finding for the template the best matching location in the target image. A pre-defined similarity function determines the matching criterion and typical examples include Euclidean distance, Correlation and Mutual Information.

The biggest drawback of block matching is its computational inefficiency. If one considers an image of size nx×ny, and a template k×k. Block matching finds the best match by measuring a similarity function between the template and image at all possible locations in the image. For example, for similarity function that treats each pixel independently a k×k calculation at all (nx-k)×(ny-k) possible locations is performed and this is computationally expensive.

One approach to reduce the computational load is to reduce the search area in the target around some local region which is assumed to contain the best matching block.

An alternative method for implementing block matching is to use the Fast Fourier Transforms (FFT) to evaluate the similarity function in a more efficient manner. This is still a somewhat computationally expensive technique.

The paper “Real-Time Pattern Matching Using Kernels”, Y. Hel-Or et al. et al. and H. Hel-Or et al. et al., IEEE Transactions on Pattern Analysis and Machine Intelligence, Vol. 27, No. 9, September 2005, describes an approach to block matching using projection kernels. The Hel-Or et al. et al. method works by avoiding the full calculation of the Euclidean distance between the pattern and all the locations. Instead a lower bound on this distance is developed in a recursive manner and combined with a location rejection scheme. Their method operates in the following manner.

The image is defined as nx×ny array (nx is the number of rows, and ny the number of columns), and the template p as a k×k array. Therefore, there are (nx-k)×(ny-k) windows, wᵢ to compare in the image; here i represents the index of the ith window. The windows and pattern can be represented as vectors in a k² dimensional space, illustrated FIG. 2. FIG. 3 illustrates the concept in a three dimensional space. The template is represented by vector p and the ith window as the vector wᵢ. The conventional approach to block matching would compare the Euclidean distances between the vectors; this involves calculating the norm r=∥P-wᵢ∥ where r is the vector connecting the points p and wᵢ.

If the vectors p and wᵢ are first projected onto a basis vectors before calculating the norm then it can be proved (see Hel-Or et al. et al. cited above) that the resultant norm is a lower bound on the norm between the two original vectors. Moreover, if the vectors p and wᵢ are projected onto a second basis vector which is orthogonal to the first basis vector and the calculated norm, then the sum of this norm with that calculated after the first projection is also a lower bound on the original norm. This new lower bound is also guaranteed to be the same or a tighter bound than the either the previous bounds.

The Hel-Or et al. et al. method works by estimating these bounds for all windows using a series of projections and then after each projection rejecting those locations whose lower bounds exceed a pre-defined threshold. The process is stopped once the only a handful of window remain or a pre-determined number of projections have been performed.

To be faster than the conventional block matching method, the projections must be performed is a very fast way and the first few projections should produce good lower bounds. To this end, the Walsh-Hadamard basis functions are used. This particular basis set allows the projections to be performed in a tree like manner where already calculate projections can be used to estimate subsequent projections. Also, it is a binary basis, meaning that only addition and subtraction operations need to be performed rather than a conventional dot product operation, which would be more costly. These optimizations make the computation much faster than the multiply-accumulate operations required for general projections.

However, the problem with the technique as described in Hel-Or et al. et al. article is that it offers no method by which the rejection threshold or stopping criterion can be set. It must be done empirically and will ultimately depend on the exact contents of each image and template pair. This significantly limits the practical utility of the technique.

To illustrate the problem, it must be considered first which rejection threshold to use when no prior knowledge is available on the pattern and the closest window (the closest window is still unknown at this stage). If a small threshold is chosen, every window is likely to be rejected after the first few projections, even the closest ones. If too high a threshold is set, then many windows may be kept even after all the projections, the processing of which will be computationally expensive.

### The Effect of the Choice of Threshold

FIG. 4 shows the Euclidean distances and the second lower bound of a particular template and test image. For clarity only a cross-section of the full surfaces is shown. It shows the distances computed at all the locations along a line in an example image). The optimal match, i.e. the point on the x-axis at which the Euclidean distance, shown by plot 1, is at a minimum, is at position 240 (vertical line 2). The lower bound, shown by plot 3, never exceeds the Euclidean distance.

Now consider the performance of the technique using the various thresholds indicated. Threshold T1, is smaller than every Euclidean distance. If this threshold is used then it is highly likely that the lower bound exceeds its value only after a few projections, including that of the optimal location. This kind of threshold is too aggressive, because it often causes the rejection of every location, even the optimal one.

For threshold T2 the Euclidean distance of many locations will be lower than its value and hence will not be rejected. However, this leads to a long computation time since few windows are rejected though the global optimum is likely to be found. Moreover, it can lead to excessively long computation times if the stopping criterion is defined with a threshold on the number R of remaining windows. If the stopping criteria is R and the number of windows that will never be rejected is N and R<N then the algorithm will not terminate until all projections have completed. Choosing this threshold will lead to even slower performance than the conventional method.

Finally threshold T3 is greater than all the Euclidean distances between the template and image. Here, no windows will be rejected during the projections and the computational time very high.

An ideal threshold is one which is close to the true Euclidean distance of the closest window; however this cannot be known at the start of the processing.

### The Effect of the Stopping Criteria

FIG. 5 shows the number of remaining windows after each projection of a particular template and image pair. In this case, the closest location has been rejected after the second projection, which should not be the case.

In that example, if the criterion is the number of projection N:
N=1 would permit to keep the optimal window, but among 2625 others. So we would need to calculate the 2625 Euclidean distances to find the best one, which is slow.
N=2 would lead to a false result, because after 2 projections 42 locations remain, but none of them is the optimal one.
N>2 would lead to nothing, because no location remain after 3 projections.

If the criterion is the maximum number of remaining windows R:
R>2625 would permit to find the closest location after the first projection, but would mean 2625 Euclidean distances to calculate
R<2625 and R>42 would lead to a false result, after the second projection
R<42 would lead to nothing.

It is evident that the appropriate setting of the rejection threshold and stopping criterion are key to the successful and practical application of the technique. Moreover, the optimal setting cannot be determined without experiment on the pair of images under consideration. In effect, the Hel-Or et al. technique is very difficult to control.

### SUMMARY OF THE INVENTION

This invention solves the problem of choosing the parameters for the Hel-Or et al. technique such that the closest location is guaranteed to be found whilst maintaining the efficient run-time. Effectively, this invention enables the practical implementation of the Hel-Or et al. technique; without it the technique is of limited applicability.

The parameters of the Hel-Or et al. technique have been set manually. The Hel-Or et al. article advocates the use of image noise variance as a guide for the threshold but this has only been shown to be useful in synthetically generated noisy images. In practice, the effectiveness of the algorithm is highly dependent of the correct setting of the three main parameters.

According to the invention a method of matching a template to a signal, using a function giving a measure of a similarity between the template and any block of the signal having dimensions of the template (Similarity Function), includes the steps of calculating an initial lower bound on the Similarity Function for a number of blocks of the signal, determining a threshold by calculating the value of the Similarity Function between the template and the block having the nth lowest lower bound and adding an increment to that value, rejecting those blocks for which the lower bound is greater than the threshold, and recalculating an improved lower bound on this similarity function for the remaining blocks. These steps are repeated until a predetermined number of blocks remain.

### DESCRIPTION OF THE DRAWINGS

FIG. 1 illustrates an example of the block matching process on three possible locations in an image.

FIG. 2 illustrates the representation of each window and pattern of an image as a vector in k×k dimensional space.

FIG. 3 illustrates the concept of projecting vectors on to basis vectors.

FIG. 4 shows a cross-section of the similarity surfaces shown for a particular template and test image.

FIG. 5 illustrates the effect of different stopping criteria on the block matching algorithm.

FIG. 6 depicts the variation of threshold as it is automatically adjusted by the proposed invention.

FIG. 7 illustrates the progression of threshold compared to the lower bound as a function of progressions.

FIG. 8 shows a comparison of the lower bounds of the closest window that of a good but sub-optimal window.

FIG. 9 shows the progression until convergence of the technique according to the invention.

FIG. 10 shows a comparison of the run-time of the unmodified Hel-Or algorithm to that of the current invention.

FIG. 11 illustrates run-times for a 512×512 image comparing the unmodified technique with different thresholds to the automated technique.

FIG. 12 illustrates run-times with the method of the invention for various sizes of template and image.

FIG. 13 illustrates run-times with the conventional method for various sizes of template and image.

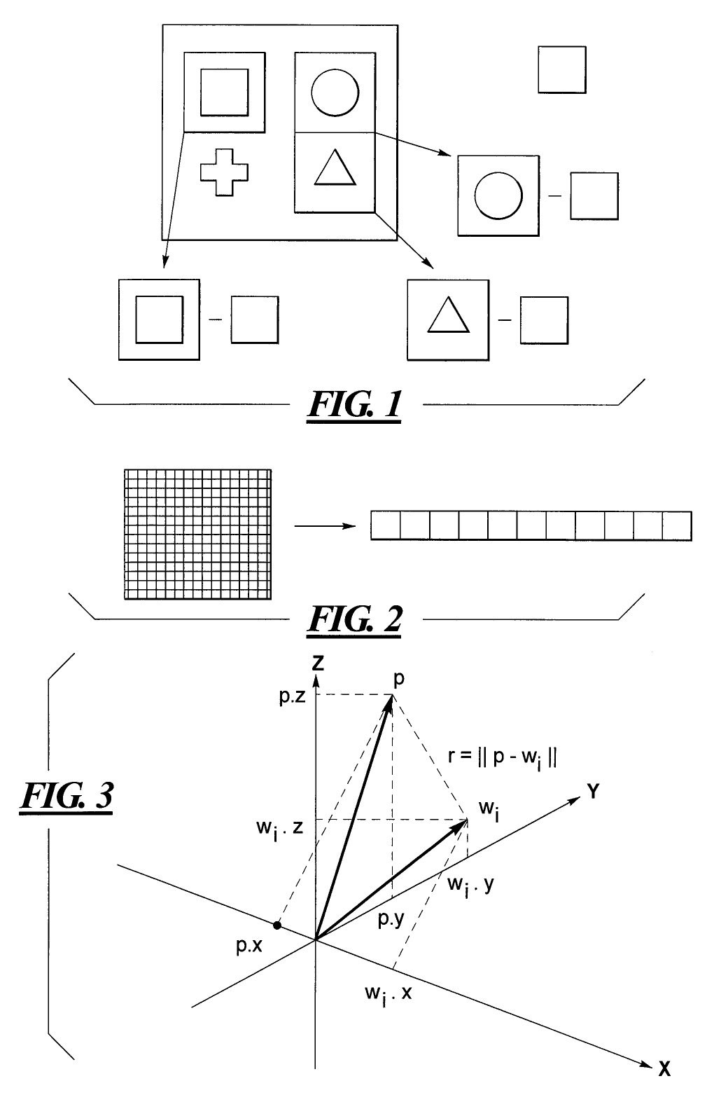

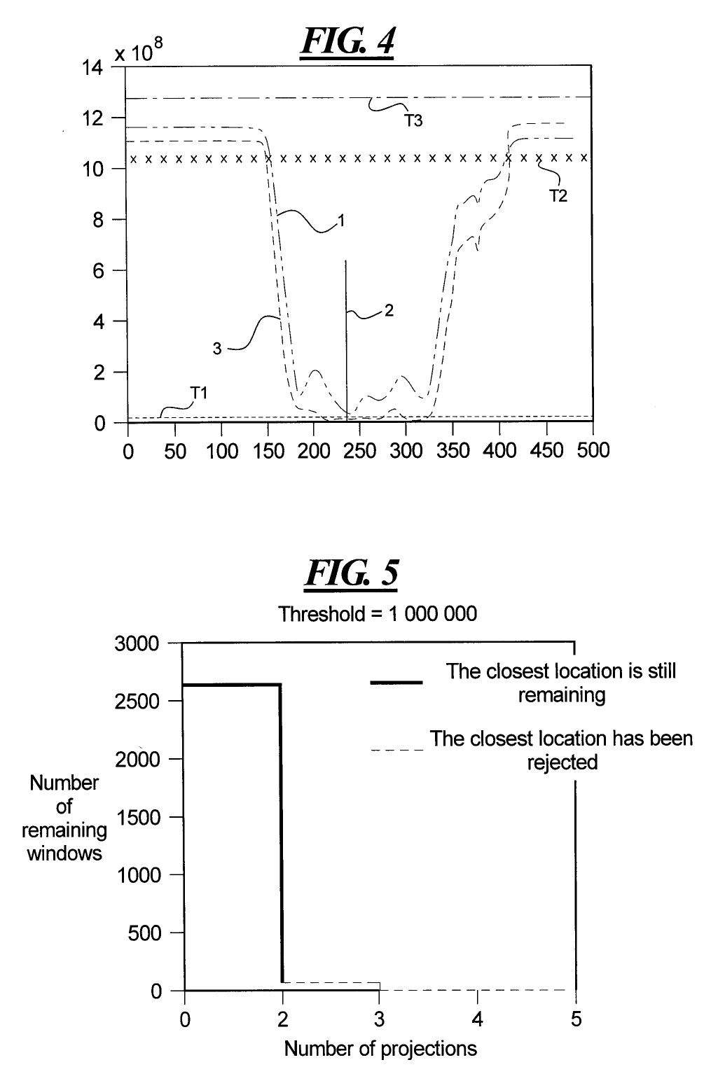

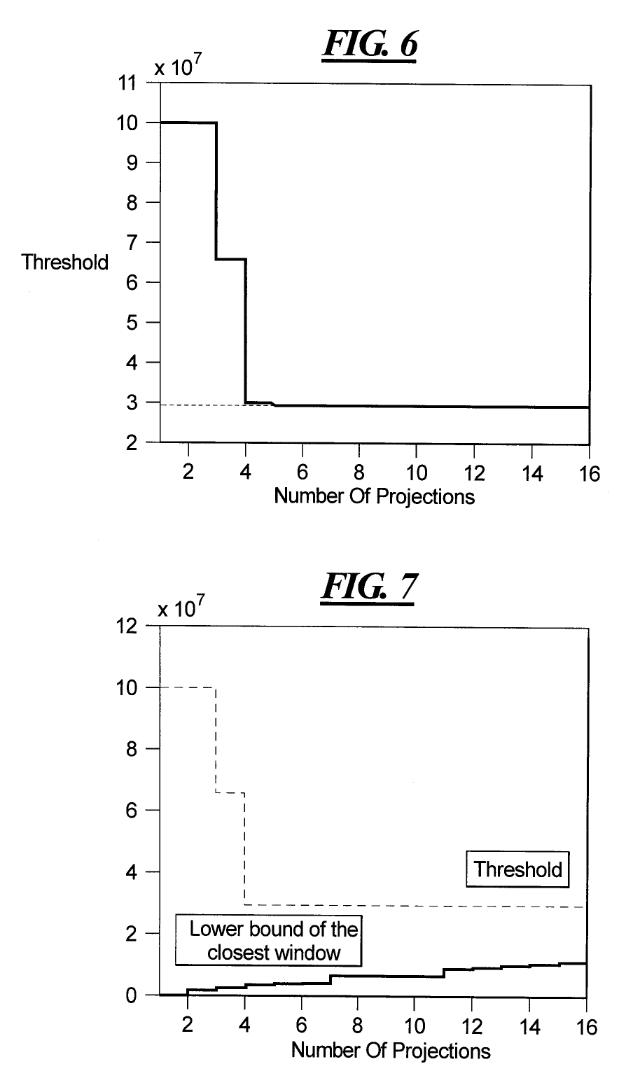

### DESCRIPTION OF THE PREFERRED EMBODIMENTS

The following technique makes a good choice of threshold automatically that is guaranteed to fine the globally best matching result. It also removes the problem of defining the stopping criteria.

As noted, that after each projection, a lower bound on the Euclidean distance is obtained for each location. If the closest window is denoted as E, that is, the location with the smallest Euclidean distance, and D its Euclidean distance from the template then the lower bounds of W are always smaller than D, although the lower bounds of the other windows (which have their Euclidean distance higher than D), tend to equal the actual Euclidean distance, so may exceed D at some point.

It is clear that D+1 (or D+delta where delta is some small value) is an ideal threshold. It only accepts the closest window, rejecting all the other ones as soon as their lower bound exceeds it. The goal is to use thresholds which are close to this ideal value, until the end of the process. The proposed invention adds two steps to the Hel-Or technique.

1) Initialization: The first projection is performed and the first set of lower bounds is obtained for all locations. Next, the location which has the smaller lower bound is selected. The Euclidean distance, d, between this window and the template is calculated. The value d+1 is used as the threshold. Since d≧D the optimal location will never be rejected and since it can be assumed that this location is quite close to the template the threshold will be quite close to the optimal.

2) Updating the threshold: After each projection, all the lower bounds of all the remaining windows are updated. If the window with the smallest lower bound changes, the Euclidean distance to the template is recalculated and used as the new rejection threshold (adding one as above) if it is smaller than the current rejection threshold. In this manner the rejection threshold approaches that of the ideal location. The process repeats until the window with the smaller lower bound becomes W, and d becomes D.

FIG. 6 shows the automated variation of the threshold as a function of the number of projections. The pattern and template were taken from a whole-body CT image. it should be noted that the technique automatically modifies the threshold (solid line) until it becomes equal to the smallest Euclidean distance +1 (dotted line, considered as the ideal threshold). In the case illustrated by FIG. 6, the threshold reached this value after the fourth projection.

FIG. 7 shows the evolution of the threshold compared to the evolution of the lower bound of the closest window. As expected, the lower bound never exceeds the threshold; this guarantees that the best match is never rejected.

FIG. 8 compares the lower bounds of the best match to that of a good but sub-optimal window, and illustrates how the sub-optimal window is rejected at the 4 projection.

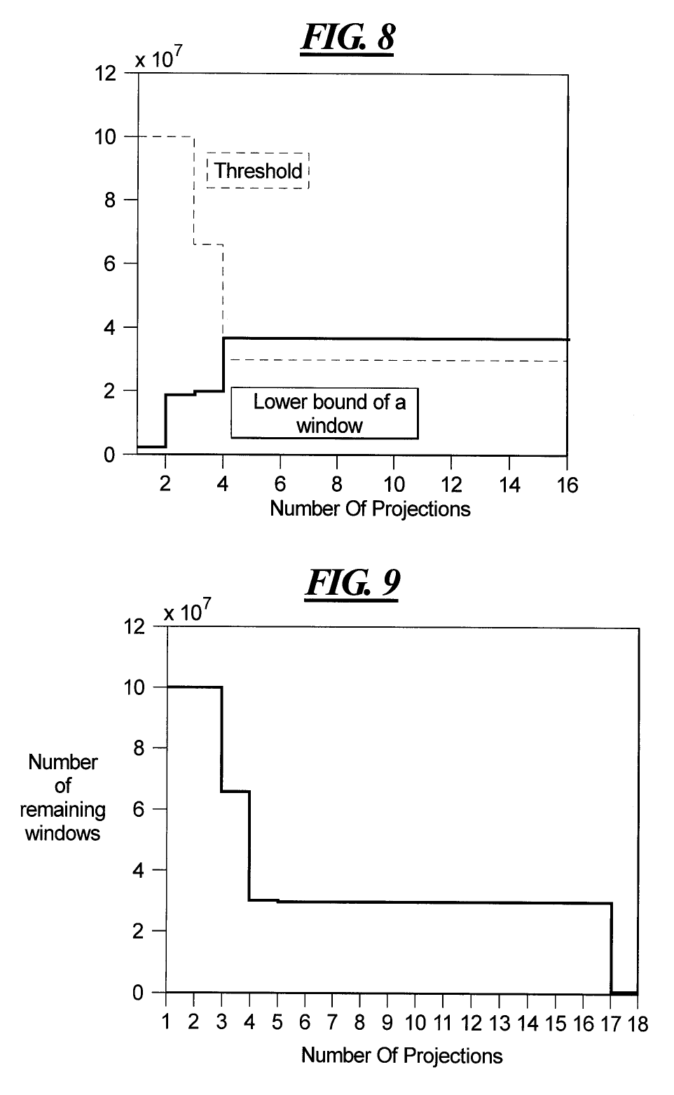

Finally, after the 17^{th} projection only one window remains and this is the closest one i.e. guaranteed to be the optimal result (FIG. 9).

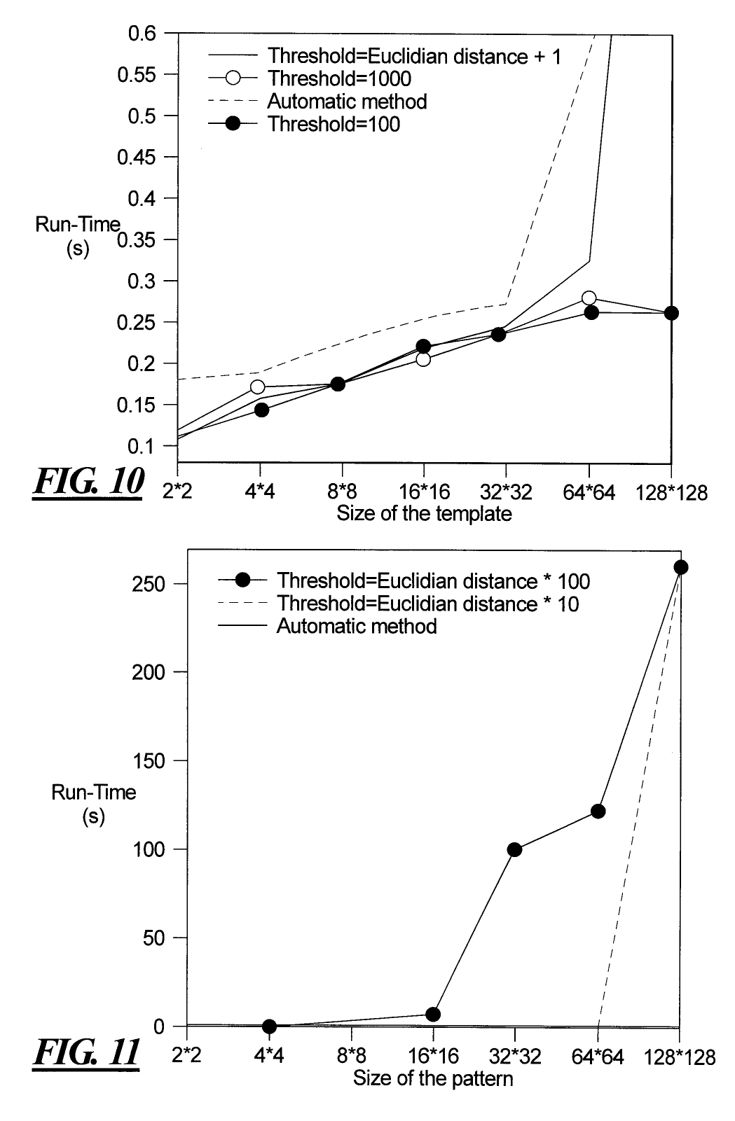

FIG. 10, shows a comparison of the run-time of the unmodified Hel-Or algorithm to that of the invention. Note that although there is a very slight reduction in speed, many of the runs with the unmodified algorithm gave the wrong result, indicated by the filled and empty circles. The method of the invention is significantly faster than the conventional approach.

It should be noted that the automation of the parameter choice does not degrade the run-time advantages of the Hel-Or method, as illustrated in FIG. 10.

Here, the experiments have been conducted with a 512×512 image whilst varying the template size. The red line represents the run-time with the automated method. The blue line is the unmodified method but with the ideal choice of parameters (the threshold equals the Euclidean distance of the closest location plus one). The non-automated version is slightly faster, because of the slight overhead in calculating the parameters threshold but it should be noted that the ideal threshold can only be determined after running block matching, therefore this ideal run-time cannot be achieved in practice.

To illustrate this point FIG. 11 shows the practical run-times of the original method with two thresholds, 10× and 100× the ideal Euclidean distance, and that of the invention.

The solid line represents the run-time for the automated method. The solid line with circles and dashed lines show the run-times for the unmodified method. It is evident that the run-time of the original algorithm becomes very large under certain conditions and more problematic such conditions are difficult to determine before the technique is applied. The invention gives an efficient implementation that is guaranteed to result in the optimal match.

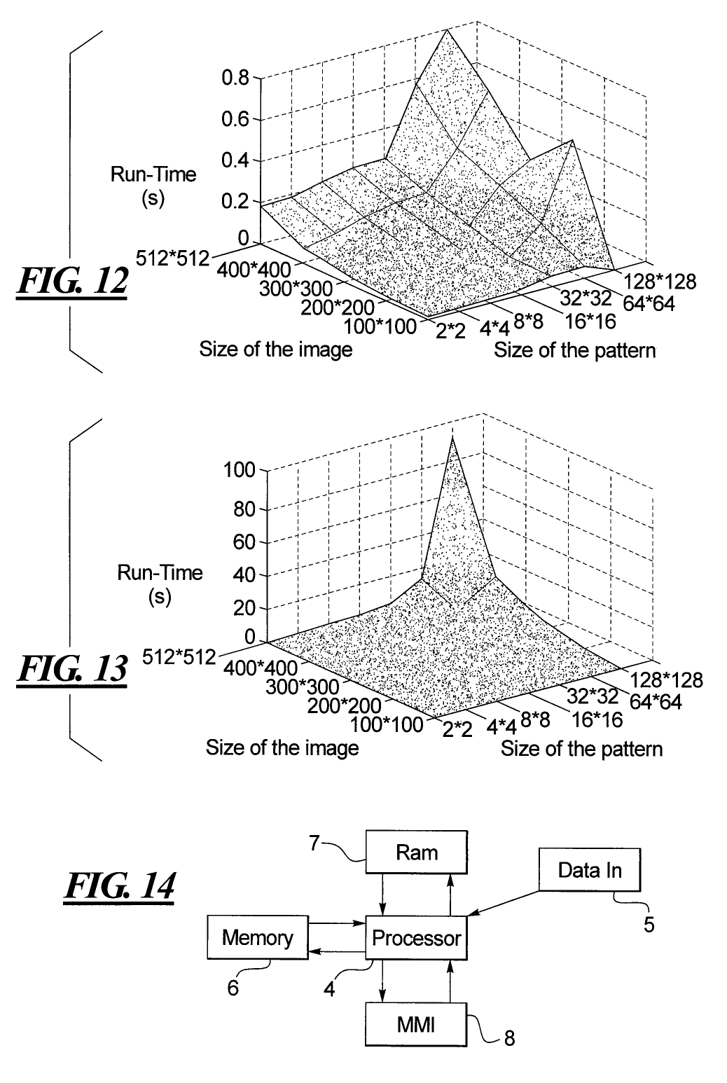

FIGS. 12 and 13 compare the run-times of the conventional block matching approach to that of the invention for different image and template sizes. If is clear from the scale on the run-time axis that the proposed method is significantly faster than the conventional approach.

In an alternative embodiment of the invention, The automation of the parameters can be easily extended in order not to find only the closest location, but the X closest locations in the image, because in some situation, finding only the closest location is not sufficient if D1, D2, . . . , DX denote the Euclidean distance the 1^{st}, the 2^{nd}, . . . and the X^{th} closest locations have, then to find the X closest locations the ideal threshold is not D1+1, but DX+1. So after each projection, a threshold is needed that is the Euclidean distance of the location which has the Xth smallest lower bound. Indeed, and this guarantees that the X closest locations have their lower bound smaller than this threshold, so as to be sure that they won't be rejected.

The automation of the parameters can be easily extended in order not to find only the closest location, but the X closest locations in the image, because in some situation, finding only the closest location is not sufficient Referring to FIG. 14, the invention may be conveniently realized as a computer system suitably programmed with instructions for carrying out the steps of the method according to the invention.

For example, a central processing unit 4 is able to receive data representative of an image via a port 5 which could be a reader for portable data storage media (e.g. CD-ROM); a direct link with apparatus such as a medical scanner (not shown) or a connection to a network.

Software applications loaded on memory 6 are executed to process the image data in random access memory 7.

A Human—Machine interface 8 typically includes a keyboard/mouse combination (which allows user input such as initiation of applications and a screen on which the results of executing the applications are displayed.

Although modifications and changes may be suggested by those skilled in the art, it is the intention of the inventor to embody within the patent warranted hereon all changes and modifications as reasonably and properly come within the scope of her contribution to the art.

I claim as my invention:

1. A method of matching a template to a signal, using a function giving a measure of a similarity between the template and any block of the signal having dimensions of the template (Similarity Function), comprising the steps of:
(i) calculating an initial lower bound on the Similarity Function for a number of blocks of the signal;
(ii) determining a threshold by calculating the value of the Similarity Function between the template and the block having the nth lowest lower bound and adding an increment to said value;
(iii) rejecting those blocks for which the lower bound is greater than the threshold;
(iv) recalculating an improved lower bound on the Similarity Function for the remaining blocks; and
(v) repeating steps (ii) to (iv) until a predetermined number of blocks remain.

2. A method according to claim 1, wherein the Similarity Function is a function of Euclidean distance.

3. A method according to claim comprising employing the lowest lower bound as the nth lowest lower bound.

4. An apparatus for matching a template to a signal comprising:
a processor configured to employ a function that is a measure of a similarity between a template and any block of an incoming signal having dimensions of the template (Similarity Function);
said processor being configured to calculate an initial lower bound on the Similarity Function for a number of blocks of the incoming signal;
said processor being configured to determine a threshold by calculating the value of the similarity function between the template and the block having the small n^{th} lowest lower bound and adding an increment to said value;
said processor being configured to reject those blocks of the incoming signal for which the lower bound is greater than the threshold;
said processor being configured to recalculate an improved lower bound on the Similarity Function for the remaining blocks; and
said processor being configured to repeat calculation of the initial lower bound of the Similarity Function, to determine said threshold, to reject those blocks for which the lower threshold bound is greater than the threshold, and to recalculate said improved lower bound on the Similarity Function, until a predetermined number of blocks remain.

5. A computer-readable medium encoded with programming instructions, said computer-readable medium being loadable into a computer and said programming instructions causing said computer to:
(i) calculate an initial lower bound on the Similarity Function for a number of blocks of the signal;
(ii) determine a threshold by calculating the value of the Similarity Function between the template and the block having the nth lowest lower bound and adding an increment to said value;
(iii) reject those blocks for which the lower bound is greater than the threshold;
(iv) recalculate an improved lower bound on the Similarity Function for the remaining blocks; and
(v) repeat steps (ii) to (iv) until a predetermined number of blocks remain.
